(19) United States
(12) Patent Application Publication
(10) Pub. No.: US 2026/0332267 A1
(43) Pub. Date: Oct. 22, 2026

(54) SIGNAL PROCESSING METHOD, DEVICE, AND SYSTEM

(71) Applicant: InnoLight Technology (Suzhou) Ltd., Suzhou, Jiangsu (CN)

(72) Inventor: Ning Cheng, Suzhou, Jiangsu (CN)

(21) Appl. No.: 18/993,718

(22) PCT Filed: Jun. 6, 2023
(86) PCT No.: PCT/CN2023/098494

§ 371 Date: Jan. 13, 2025

(30) Foreign Application Priority Data
Jul. 18, 2022 (CN) 202210838818.5

(51) Int. Cl. H04B 10/524; H04B 10/54; H04B 10/60

(52) U.S. Cl. CPC H04B 10/524; H04B 10/541; H04B 10/60

(57) ABSTRACT

The present invention relates to a signal processing method, device, and system. The method comprises: performing direct-current balance coding on a signal sent by a signal source, so as to obtain a coded signal; modulating the coded signal to obtain a modulated signal; and sending the modulated signal to a receiving end so as to instruct the receiving end to perform high-pass filtering processing on the received modulated signal to obtain a modulated signal of which the frequency is higher than a preset value, and demodulating and decoding the modulated signal of which the frequency is higher than the preset value, so as to obtain a processed signal. According to embodiments of the present invention, high-pass filtering processing is performed on the received modulated signal at the receiving end to obtain the modulated signal of which the frequency is higher than the preset value, such that the effect of MPI noise on the transmission performance can be effectively reduced, and the tolerance to the MPI noise is improved.

### CROSS-REFERENCE TO RELATED PATENT APPLICATION

The present disclosure claims priority to the Chinese patent application filed with the China Patent Office on Jul. 18, 2022, with the application number 202210838818.5 and the invention title “SIGNAL PROCESSING METHOD, DEVICE AND SYSTEM”, the entire content of which is incorporated into the present disclosure by reference.

### FIELD OF THE DISCLOSURE

The present disclosure relates to the field of communication technology, and in particular to signal processing methods, devices and systems.

### BACKGROUND TECHNIQUE

With the advancement of communication technology, high-order modulation techniques, such as pulse amplitude modulation (PAM) and dual-binary modulation, have emerged to enhance bit rates. However, high-order modulated signals are more vulnerable to multi-path interference (MPI) effects during transmission. In practical transmission systems, reflections caused by the optical transmitting end, optical receiving end, and optical fiber connectors lead to multipath interference. When the modulated signal traverses multiple reflective surfaces, a multipath interference effect occurs, generating MPI noise. This MPI noise adversely affects the detection of transmitted signals, significantly increasing the bit error rate and imposing substantial optical power costs on the optical transmission system.

In related technologies, the return loss of optical transmitting ends, optical receiving ends, and optical fiber connectors is strictly regulated. For example, international standards such as IEEE 802.3 and 100G Lambda MSA have reduced the maximum allowable return loss of optical fiber connectors from the original −26 dB to −35 dB. However, in deployed optical fiber links, due to the presence of numerous optical fiber connectors and the difficulty in maintaining their return loss below −35 dB, MPI noise in actual systems can significantly impact modulated signals. This often results in higher optical power costs. In some cases, even with the use of complex forward error correction (FEC) techniques, error-free transmission remains unachievable. Reducing the impact of multipath interference on optical transmission systems continues to be a challenging issue for the industry.

### SUMMARY OF THE DISCLOSURE

The present disclosure provides a signal processing method, a device and a system to at least solve the problem in related technologies of reducing the impact of multipath interference noise on optical transmission. The technical solutions of the present disclosure are as follows.

According to a first aspect of the embodiment of the present disclosure, a signal processing method is provided, which is applied to the transmitting end, and the method includes:
performing DC balance coding on a signal emitted by a signal source to obtain a coded signal;
performing modulation processing on the coded signal to obtain a modulated signal; and
transmitting the modulated signal to a receiving end to instruct the receiving end to perform high-pass filtering on a received modulated signal to obtain a modulated signal with a frequency higher than a preset value, and
performing demodulation processing and decoding processing on the modulated signal with the frequency higher than the preset value to obtain a processed signal.

In a possible implementation, the modulation processing includes a pulse amplitude modulation processing, and performing the DC balance coding on the signal emitted by the signal source to obtain the coded signal includes:
determining a number of signals transmitted by the signal source to be demultiplexed according to a modulation order of a pulse amplitude modulation; and
demultiplexing the signal into a number of sub-signals;
performing the DC balance coding on the number of sub-signals respectively to obtain a number of sub-coded signals;
wherein performing the modulation processing on the coded signal to obtain the modulated signal includes:
performing the pulse amplitude modulation according to the number of sub-coded signals to obtain the modulated signal.

In a possible implementation, performing the pulse amplitude modulation on the sub-coded signals according to the number of sub-coded signals to obtain the modulated signal, includes:
converting the number of sub-coded signals into Gray code signals according to Gray code conversion rule; and
performing the pulse amplitude modulation according to the Gray code signals to obtain the modulated signal.

In a possible implementation, the modulated signal includes a duobinary modulated signal, and performing the modulation processing on the coded signal to obtain the modulated signal includes:
performing duobinary modulation to the coded signal to obtain a duobinary modulated signal.

In a possible implementation, the modulated signal includes a duobinary modulated signal, and performing the modulation processing on the coded signal to obtain the modulated signal includes:
obtaining a coded signal delayed by a preset number of bits from the coded signal;
performing XOR processing on the coded signal and the coded signal delayed by the preset number of bits to obtain a pre-coded signal; and
performing pre-coding processing and duobinary modulation processing on the pre-coded signal to obtain the duobinary modulated signal.

In a possible implementation, the DC balanced coding includes at least one of the following:
8B10B coding, MB810 coding, 5S/6S coding, and 27S/32S coding.

According to a second aspect of the embodiment of the present disclosure, a signal processing device is provided, characterized in that it includes:
a coding module, configured to perform DC balance coding on a signal emitted by a signal source to obtain a coded signal;
a modulation module, configured to perform modulation processing the coded signal to obtain a modulated signal;
a processing module, configured to transmit the modulated signal to a receiving end to instruct the receiving end to perform high-pass filtering on a received modulated signal to obtain a modulated signal with a frequency higher than a preset value, and perform demodulation processing and decoding processing on the modulated signal with the frequency higher than the preset value to obtain a processed signal.

In a possible implementation, the modulation processing includes a pulse amplitude modulation processing, and the coding module includes:
a determination sub-module, configured to determine a number of signals transmitted by the signal source to be demultiplexed according to a modulation order of a pulse amplitude modulation;
a demultiplexing sub-module, configured to demultiplex the signal into a number of sub-signals;
a coding sub-module, configured to perform the DC balance coding on the number of sub-signals respectively to obtain a number of sub-coded signals;
wherein the modulation module includes:
a first modulation sub-module, configured to perform the pulse amplitude modulation according to the number of sub-coded signals to obtain the modulated signal.

In a possible implementation, the first modulation sub-module includes:
a conversion unit, configured to convert the number of sub-coded signals into Gray code signals according to Gray code conversion rule; and
a modulation unit, configured to the pulse amplitude modulation according to the Gray code signals to obtain the modulated signal.

In a possible implementation, the modulated signal includes a duobinary modulated signal, and the modulation module includes:
a second modulation sub-module, configured to perform duobinary modulation to the coded signal to obtain the duobinary modulated signal.

In a possible implementation, the modulated signal includes the duobinary modulated signal, and the modulation module includes:
an obtaining sub-module, configured obtain to a coded signal delayed by a preset number of bits from the coded signal;
a processing sub-module, configured to perform XOR processing on the coded signal and the coded signal delayed by the preset number of bits to obtain a pre-coded signal; and
a third modulation sub-module, configured to perform pre-coding processing and duobinary modulation processing on the pre-coded signal to obtain the duobinary modulated signal.

In a possible implementation, the DC balanced coding includes at least one of the following:
8B10B coding, MB810 coding, 5S/6S coding, and 27S/32S coding.

According to a third aspect of the embodiment of the present disclosure, a signal processing system is provided, characterized by including a transmitting end and a receiving end, wherein the transmitting end includes:
an encoder, configured to perform DC balanced coding on a signal emitted by a signal source to obtain a coded signal;
a modulator, configured to perform modulation processing on the coded signal to obtain a modulated signal; and
a modulated laser, configured to transmit the modulated signal to the receiving end;
wherein the receiving end includes:
a photoelectric receiving end, configured to receive a modulated signal;
a high-pass filter, configured to perform high-pass filtering on a received modulated signal to obtain a modulated signal with a frequency higher than the preset value; and
a decoder, configured to demodulate and decode the modulated signal with the frequency higher than the preset value to obtain a processed signal.

According to a fourth aspect of the embodiment of the present disclosure, an electronic device is provided, characterized by including:
a processor;
a memory, configured to store instructions executable by the processor;
wherein, the processor is configured to execute the instructions to implement the signal processing method according to any one as mentioned above.

According to a fifth aspect of the embodiment of the present disclosure, a computer-readable storage medium is provided, characterized in that, when the instructions in the computer-readable storage medium are executed by a processor of an electronic device, the electronic device is enabled to perform the signal processing method as according to any one as mentioned above.

According to a sixth aspect of the embodiment of the present disclosure, a computer program product is provided, the computer program product including instructions, characterized in that when the instructions are executed by a processor of an electronic device, the electronic device can perform the signal processing method according to any one as mentioned above.

The technical solution provided by the embodiments of the present disclosure yields at least the following beneficial effects. In the embodiments of the present disclosure, DC balance coding is applied to the signal emitted by the signal source to obtain a coded signal. Through DC balance coding, the number of high levels and low levels in the signal can be kept equal. After modulating the coded signal, the energy of the modulated signal in the low-frequency band near zero frequency becomes significantly low. Therefore, in the embodiment of the present disclosure, high-pass filtering is performed on the received modulated signal at the receiving end to obtain a modulated signal with a frequency higher than a preset value. This approach effectively reduces the impact of MPI noise on transmission performance and enhances the tolerance to MPI noise.

It should be understood that the foregoing general description and the following detailed description are provided solely for exemplary and explanatory purposes and are not intended to limit the scope of the present disclosure.

### BRIEF DESCRIPTION OF THE DRAWINGS

The drawings provided herein are incorporated into and constitute a part of this specification. They illustrate embodiments consistent with the present disclosure and, together with the description, are configured to explain the principles of the disclosure. However, they do not impose any undue limitations on the scope of the disclosure.

FIG. 1 is an application environment diagram of a signal processing method according to an exemplary embodiment;

FIG. 2 is a flow chart of a signal processing method according to an exemplary embodiment;

FIG. 3 is a schematic diagram of the MPI noise spectrum generated by PAM4 signal transmission through optical fiber according to an exemplary embodiment;

FIG. 4 is a schematic diagram of the MPI noise spectrum generated by PAM4 signal transmission through optical fiber according to another exemplary embodiment;

FIG. 5 is a schematic diagram of the MPI noise spectrum generated by PAM4 signal transmission through optical fiber according to another exemplary embodiment;

FIG. 6 is a flow chart of a signal processing method according to another exemplary embodiment;

FIG. 7 is a flow chart of a signal processing method according to another exemplary embodiment;

FIG. 8 is a flow chart of a signal processing method according to another exemplary embodiment;

FIG. 9 is a flow chart of a signal processing method according to another exemplary embodiment;

FIG. 10 is a flow chart of a signal processing method according to another exemplary embodiment;

FIG. 11 is a flow chart of a signal processing method according to another exemplary embodiment;

FIG. 12 is a schematic diagram of the power spectrum of an 8B10B coded PAM4 signal according to an exemplary embodiment;

FIG. 13 is a schematic diagram of the power spectrum of a duobinary signal according to another exemplary embodiment;

FIG. 14 is a schematic diagram of a bit error rate curve of 25 Gbaud PAM4 optical signal transmission according to an exemplary embodiment;

FIG. 15 is a schematic diagram of the optical power cost of the 25 Gbaud PAM4 optical transmission system under different MPIs according to another exemplary embodiment;

FIG. 16 is a schematic block diagram of a signal processing device according to an exemplary embodiment;

FIG. 17 is a schematic block diagram of an electronic device according to an exemplary embodiment.

### DETAILED DESCRIPTION OF THE EXEMPLARY EMBODIMENTS

In order to allow ordinary people in the art to better understand the technical solutions of the present disclosure, the technical solutions in the embodiments of the present disclosure will be clearly and completely described below in conjunction with the accompanying drawings.

It should be noted that the terms “first”, “second”, etc. in the description and claims of the present disclosure and the above-mentioned drawings are configured to distinguish similar objects and are not necessarily configured to describe a specific order or sequence. It is to be understood that the data so used are interchangeable under appropriate circumstances so that the embodiments of the disclosure described herein can be practiced in sequences other than those illustrated or described herein. The implementations described in the following exemplary embodiments do not represent all implementations consistent with the present disclosure. Rather, they are merely examples of apparatus and methods consistent with aspects of the disclosure as detailed in the appended claims.

It should also be noted that the user information (including but not limited to user equipment information, user personal information, etc.) and data (including but not limited to data for display, analyzed data, etc.) involved in the present disclosure are all obtained from users. Information and data authorized or fully authorized by all parties.

In order to facilitate those skilled in the art to understand the technical solutions provided by the embodiments of the present disclosure, the technical environment in which the technical solutions are implemented is first described below.

Given the impact of MPI noise on high-order modulated signals, filtering methods in related technologies are employed to reduce noise. However, when MPI noise is significant or the high-order modulated signal exhibits large chirps, these methods fail to effectively filter out MPI noise. For high-order modulated signals generated by a Directly Modulated Laser (DML), the inherent large chirp in the signal causes MPI noise to extend into higher frequencies. Consequently, conventional filtering methods are largely ineffective in mitigating MPI noise. Furthermore, at the receiving end, the filtered high-order modulated signal may exhibit DC drift, which adversely affects the recovery of the modulated signal.

Based on actual technical requirements similar to those described above, embodiments of the present disclosure propose a signal processing method, a device, and a system.

The signal processing method provided by the present disclosure can be applied in the application environment as shown in FIG. 1.

The transmitting end 110 communicates with the receiving end 120 through an optical fiber. The transmitting end 110 may include, but is not limited to, various encoders and modulated lasers. The modulated lasers may include, but are not limited to, Electroabsorption-Modulated Laser (EML), Directly Modulated Laser (DML), and Mach-Zehnder Modulator (MZM, a photoelectric modulator). The receiving end 120 may include, but is not limited to, various photodiodes, transimpedance amplifiers, high-pass filters, and decoders. The signal S transmitted by the signal source undergoes DC balance coding and modulation processing, after which the optical signal is transmitted via the modulated laser. During the transmission of optical signals through optical fibers, MPI noise is generated due to reflections at the transmitting end, the receiving end, and within the optical fiber link. The optical signal, now containing MPI noise, is received by the photodiode at the receiving end. The photodiode converts the optical signal into an electrical signal, which is amplified by a transimpedance amplifier (TIA). The amplified signal then passes through a high-pass filter to remove low-frequency MPI noise, thereby reducing the impact of MPI noise on signal recovery. Finally, the processed signal S′ (recovered signal) is obtained.

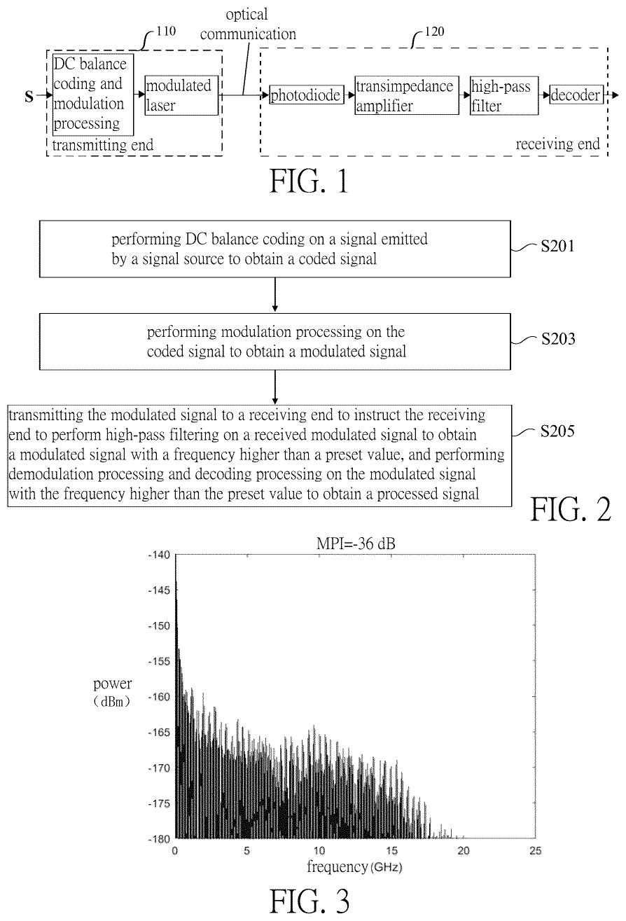

FIG. 2 is a flow chart of a signal processing method according to an exemplary embodiment. As shown in FIG. 2, the method is used in a transmitting end and includes the following steps.

In step S201, DC balance coding is performed on the signal transmitted by the signal source to obtain a coded signal.

In the embodiment of the present disclosure, the signal transmitted by the signal source is used as data to be transmitted, and its format includes but is not limited to binary, octal, and hexadecimal. The signal is subjected to DC balanced coding, where the coding method of the DC balanced coding includes but is not limited to 8B10B coding, MB810 coding, 5S/6S coding, and 27S/32S coding.

In step S203, the coded signal is modulated to obtain a modulated signal.

In the embodiment of the present disclosure, the coded signal is modulated, where the modulation method includes but is not limited to pulse amplitude modulation PAM-N (N represents the modulation order), duobinary modulation, non-return to zero binary modulation Non-Return-to-Zero (NRZ), partial response modulation, and a combination of PAM-N and partial response modulation. PAM signal elements can have multiple levels. For example, PAM4 has four levels, and PAM8 has eight levels, PAM16 has sixteen levels. Compared with PAM4 signals, duobinary coding can achieve transmission at the same bit rate under the same bandwidth. Among them, duobinary coding has three transmission levels.

In step S205, the modulated signal is transmitted to the receiving end to instruct the receiving end to perform high-pass filtering on the received modulated signal to obtain a modulated signal with a frequency higher than a preset value. The modulated signal of the value is demodulated and decoded to obtain the processed signal.

In the embodiment of the present disclosure, the modulated signal can be transmitted to the receiving end through optical fiber communication. Modulated signals are easily affected by MPI noise during transmission. The received modulated signal includes the modulated signal transmitted by the transmitting end and the MPI noise signal. At the receiving end, the received modulated signal can be converted into an electrical signal through a photodiode, the electrical signal is amplified through a transimpedance amplifier, and the amplified electrical signal is filtered through a high-pass filter to filter out the low-frequency MPI noise, and then process the filtered signal in the demodulation method and decoding method corresponding to the coding end to obtain the processed signal. For example, the coding end uses 8B10B coding, the decoding end uses 8B10B decoding, the coding end uses PAM4 modulation, and the decoding end uses PAM4 demodulation. In the embodiment of the present disclosure, the high-pass filter may include any type of high-pass filter, such as a first-order RC high-pass filter or a fourth-order Bessel high-pass filter. The present disclosure does not limit thereto.

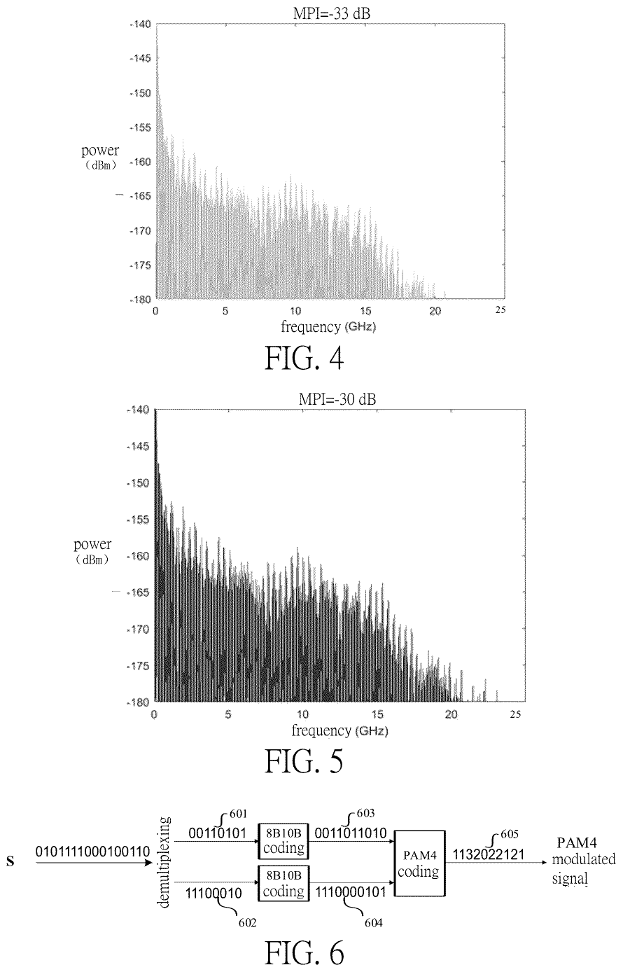

In the embodiment of the present disclosure, DC balance coding is performed on the signal emitted by the signal source to obtain a coded signal. Through DC balance coding, the number of high levels and the number of low levels in the signal can be kept equal. After using the coded signal for optical modulation, the energy of the modulated signal in the low frequency band near zero frequency can be very low (the power spectrum has very little energy in the low frequency band (below 100 MHz). Referring to FIGS. 3 to 5, the transmitting end uses a 25 Gbaud PAM4 signal to modulate the EML signal. During the transmission process in the optical fiber, MPI noise is generated due to link reflection. FIG. 3 corresponds to the effective MPI of MPI at −36 dB. Noise power spectrum, FIG. 4 corresponds to the MPI noise power spectrum when the effective MPI is −33 dB, and FIG. 5 corresponds to the MPI noise power spectrum when the effective MPI is −30 dB. It can be seen that the MIP noise power spectrum is distributed within 0-25 GHz, but the main energy is distributed in the low frequency band. Therefore, the embodiment of the present disclosure performs high-pass filtering on the received modulated signal at the receiving end to obtain a modulated signal with a frequency higher than the preset value, thereby filtering out most of the MPI noise. Therefore, in the embodiment of the present disclosure, the transmitting end uses DC balanced coding and the receiving end uses high-pass filtering technology, which can effectively reduce the impact of MPI noise on transmission performance and improve the tolerance to MPI noise. In addition, since DC balanced coding does not contain zero-frequency components, DC drift is not generated after high-pass filtering. Therefore, high-pass filtering does not affect the recovery of the modulated signal.

In a possible implementation, the modulation processing includes pulse amplitude modulation processing. Step S201, performing DC balance coding on the signal transmitted by the signal source to obtain a coded signal, includes:
determining the number of signals transmitted by the signal source to be demultiplexed according to the modulation order of pulse amplitude modulation,
demultiplexing the signal into the number of sub-signals; and
performing the DC balance coding on the number of sub-signals respectively to obtain a number of sub-coded signals.

Step S203, performing the modulation processing on the coded signal to obtain a modulated signal, includes:
performing the pulse amplitude modulation according to the number of sub-coded signals to obtain the modulated signal.

In this embodiment of the present disclosure, the pulse amplitude modulation may include PAM-N, where N represents the modulation order, such as PAM4, PAM8, PAM16 or higher-order PAM coding. According to the modulation order of pulse amplitude modulation, such as N, in one example, the number of demultiplexing signals transmitted by the signal source is determined to be log 2N. The signal is demultiplexed into the number of sub-signals. For example, when N is 4, the signal is split into two signals; when N is 8, the signal is split into three signals; when N is 16, the signal is split into four signals. A specific demultiplexing method may include sequentially allocating the code stream corresponding to the signal emitted by the signal source to a number of sub-signals corresponding to the modulation order to obtain a corresponding number of sub-coded signals. In an example, referring to FIG. 6, PAM4 is taken as an example. Since the modulation order of PAM4 is 4, the number of demultiplexing is 2. The signal transmitted by the signal source corresponds to the binary code stream 0101111000100110. This code stream is allocated to the upper and lower sub-signal code streams in sequence. For example, the first number 0 is allocated to the first sub-signal 601, and the second number 1 is allocated to the second sub-signal 602, the third number 0 is allocated to the first sub-signal 601, and the fourth number 1 is allocated to the second sub-signal 602, and so on. It happens to be that the odd-numbered digits of the binary code stream constitute the first sub-signal 601, specifically 00110101, and the even-digit numbers of the binary code stream (the numbers underlined in the aforementioned binary code stream) constitute the second sub-signal 602, specifically 11100010.

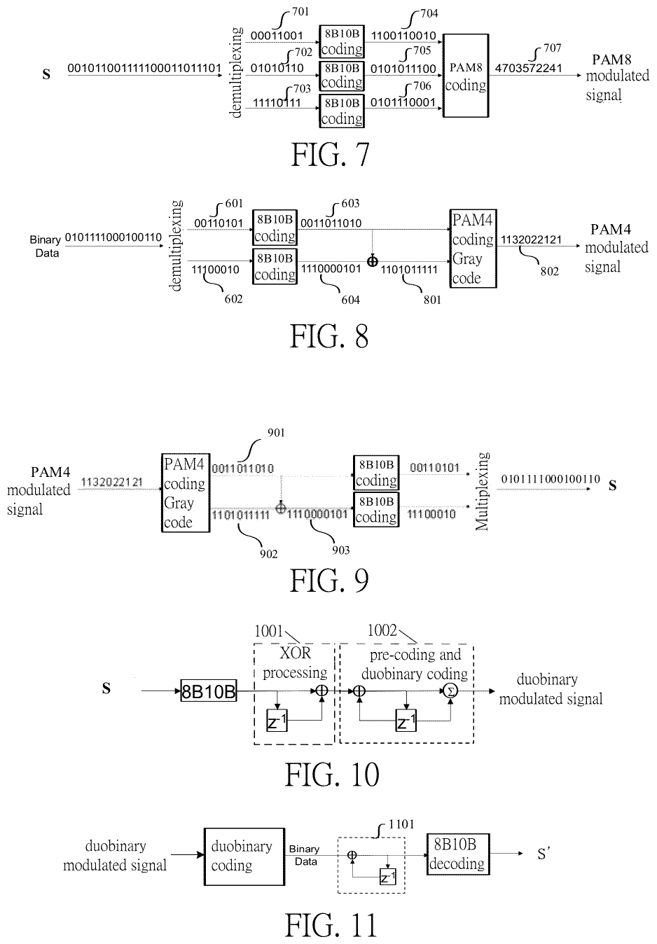

In one example, referring to FIG. 7, PAM8 is taken as an example. Since the modulation order of PAM8 is 8, the number of demultiplexed sub-signals is 3. The signal S transmitted by the signal source is 001011001111100011011101, and the code stream is sequentially allocated to the first sub-signal 701, the second sub-signal 702, and the third sub-signal 703. Specifically, the first bit 000 of the signal S is allocated to the first sub-signal 701 as the first bit of the first sub-signal 701; the second bit 1 of the signal S is allocated to the second sub-signal 702 as the first bit of the second sub-signal 702; the third bit 1 of the signal S is allocated to the third sub-signal 703 as the first bit of the third sub-signal 703; the fourth bit 0 of the signal S is allocated to the first sub-signal 701 as the second bit of the first sub-signal 701; the fifth bit 1 of the signal S is allocated to the second sub-signal 702 as the second bit of the second sub-signal 702; and the sixth bit 1 of the signal S is allocated to the third sub-signal 703 as the third bit of the third sub-signal 703, and so on. As a result, the first sub-signal 701 is 00011001, the second sub-signal 702 is 01010110, and the third sub-signal 703 is 11110111. Similarly, for PAM16, the signal from the signal source can be demultiplexed into four sub-signals. The specific demultiplexing method is the same as described above and will not be repeated here.

The number of sub-signals are respectively subjected to DC balance coding to obtain the number of sub-coded signals. DC balanced coding takes 8B10B as an example. In one example, as described with reference to FIG. 6, the first sub-signal 601 is coded by 8B10B and becomes the first sub-coded signal 603, specifically: 0011011010. The second sub-signal 602 is coded by 8B10B and becomes the second sub-coded signal 604, specifically: 1110000101. Pulse amplitude modulation is performed according to the number of sub-coded signals to obtain a modulated signal. In one example, referring to FIG. 6, the first sub-coding signal 603 can be used as the most significant bit (MSB) of PAM4, and the second sub-coding signal 604 can be used as the least significant bit (LSB) of PAM4. In another example, the first sub-coding signal 603 may also be used as the least significant bit of PAM4, and the second sub-coding signal 604 may be used as the most significant bit of PAM4. Referring to FIG. 6, taking the first sub-coding signal 603 as the most significant bit of PAM4 as an example, according to the corresponding coding rules of PAM4: binary 00 is coded as PAM4 code element 0, binary 01 is coded as PAM4 code element 1, binary 10 is coded as PAM4 code element 2, and binary 11 is coded as PAM4 code element 3. The first number 0 of the first sub-coding signal 603 is used as the most significant bit of the first code element of PAM4, and the first number 1 of the second sub-coding signal 604 is used as the least significant bit of the first code element of PAM. Then the first code element of PAM4 is 01. According to the coding rules of PAM4, 01 corresponds to code element 1, so that the first code element of PAM4 is 1. The second number 0 of the first sub-coding signal 603 is used as the most significant bit of the second code element of PAM4, and the second number 1 of the second sub-coding signal 604 is used as the least significant bit of the second code element of PAM4. According to the coding rules of PAM4, 01 corresponds to code element 1, so that the second code element of PAM4 is 1. Similarly, the PAM4 modulated signal 605 is obtained, specifically 1132022121. Next, the DC balanced properties of PAM4 modulated signal 605 are described.

Each code element of PAM4 will be represented by different levels. For example, code element 0 of PAM4 is represented by −3V, code element 1 of PAM4 is represented by −1V, code element 2 is represented by 1V, and code element 3 is represented by 3V. For the PAM4 modulated signal 605, specifically No. 1132022121, the number of high levels (e.g.: 1V, 3V) and low levels (e.g.: −1V, −3V) is equal, so it has DC balance.

The number of sub-signals are respectively subjected to DC balance coding to obtain the number of sub-coded signals. DC balanced coding takes 8B10B as an example. In one example, as described with reference to FIG. 7, the first sub-signal 701 is coded by 8B10B to obtain the first sub-coded signal 704, specifically 1100110010; the second sub-signal 702 is coded by 8B10B to obtain the second sub-coded signal 705, specifically 0101011100; and the third sub-signal 703 is coded by 8B10B to obtain the third sub-coded signal 706, specifically 0101110001. The first number 1 of the first sub-coding signal 704, the first number 0 of the second sub-coding signal 702, and the first number 0 of the third sub-coding signal 703 are respectively selected to form 100. According to the coding rules of PAM8, 100 corresponding to code element 4, 4 is used as the first code element of PAM8. Similarly, the modulated signal of PAM8 is 707, specifically 4703572241.

The above discussed how to encode the binary code stream into a DC-balanced PAM code stream. At the receiving end, it is necessary to perform an inverse transformation according to the aforementioned coding process to restore the binary code stream. Taking PAM4 using 8B10B coding as an example, refer to FIG. 8. As shown in FIG. 8, after the receiving end receives the filtered PAM4 modulated signal, the first sub-coded signal 603 and the second sub-coded signal 604 are obtained through PAM4 decoding. 8B10B is decoded on the first sub-coded signal 603 to obtain the first sub-signal 601, 8B10B is decoded on the second sub-coded signal 604 to obtain the second sub-signal 602, and the first sub-signal 601 and the second sub-signal 602 are combined according to the corresponding multiplexing method during coding to multiplex the two sub-signals together to obtain the processed signal S′.

In the embodiment of the present disclosure, DC balance can be achieved by passing an ordinary binary code stream through 8B10B coding, MB810 coding or other DC balanced coding. However, if the final line coding is PAM coding (such as PAM4, PAM8, PAM16 or higher-order PAM coding), due to PAM coding rules, the DC-balanced binary code stream will lose part or all of its DC-balanced characteristics after PAM coding. The original code stream 0101111000100110 in FIG. 6 is taken as an example. Without the demultiplexing step, DC balanced coding (8B10B) is directly performed to obtain 01011011001101010011, and then PAM4 coding is performed to obtain 1123031103. The number of high levels and low levels in the PAM4 signal obtained in this way is not equal. Therefore, the DC balanced binary code stream will lose part or all of its DC balanced characteristics after PAM coding.

Therefore, in the embodiment of the present disclosure, for the pulse amplitude modulation processing, the embodiment of the present disclosure determines the number of demultiplexed sub-signals according to the modulation order of the pulse amplitude modulation, then performs DC balance coding on the sub-signals of the number to obtain the number of sub-coded signals, and performs pulse amplitude modulation according to the number of sub-coded signals to obtain a modulated signal, which can ensure that the finally obtained modulated signal has DC balanced properties. The subsequent use of high-pass filtering technology at the receiving end can effectively reduce the impact of MPI noise on transmission performance and improve the tolerance of MPI noise.

FIG. 8 is a flow chart of a signal processing method according to an exemplary embodiment. Referring to FIG. 8, performing pulse amplitude modulation according to the number of sub-coded signals to obtain a modulated signal, includes:
converting the number of sub-coded signals into Gray code signals according to Gray code conversion rule; and
performing the pulse amplitude modulation according to the Gray code signals to obtain the modulated signal.

In the embodiment of the present disclosure, the Gray code is also called a cyclic binary code or a reflected binary code. Taking PAM4 and 8B10B coding as an example, the code stream corresponding to the signal S transmitted by the signal source, specifically 010111100100110, can be demultiplexed into the first sub-signal 601 according to the method disclosed in the above embodiment, specifically 00110101, and the second sub-signal 602 is specifically 11100010. The first sub-signal 601 and the second sub-signal 602 are respectively subjected to 8B10B coding to obtain a first sub-coded signal 603, specifically 0011011010, and a second sub-coded signal 604, specifically 1110000101. According to the Gray code conversion rule, if the bit of the first sub-coded signal 603 is 0 or 1, the bit of the second sub-coded signal 604 is inverted, that is, if the bit of the first sub-coded signal 603 is 1, then the bit of the first sub-coded signal 603 is 1, and the bits of the second sub-coding signal 604 are inverted. If the bits of the first sub-coding signal 603 are 0, the bits of the second sub-coding signal 604 are not inverted. This process can be implemented by XOR logic on the first sub-coding signal 603 and the second sub-coding signal 604, as shown in FIGS. 8, ⊕ means XOR logic (i.e. 0⊕0=0, 0⊕1=1, 1⊕0=1, 1⊕1=0). By performing Gray code conversion on the first sub-coded signal and the second sub-coded signal, Gray code signal 801 is obtained. Further, the Gray code signal is coded with PAM4 to obtain a modulated signal 802. Specifically, if the first sub-code (MSB) is 0 and the second sub-code (LSB) is 0, the PAM4 code generated after Gray code conversion is 0. If the first sub-code is 0 and the second sub-code is 1, the PAM4 code generated after Gray code conversion is 1. If the first sub-code is 1 and the second sub-code is 1, the PAM4 code generated by Gray code conversion is 2. If the first sub-code is 1 and the second sub-code is 0, the PAM4 code generated by Gray code conversion is 3.

As shown in FIG. 9, after the receiving end restores the PAM4 code stream, it becomes two binary code streams, MSB code stream 901 and LSB code stream 902 through PAM4 decoding, and then the LSB code stream 902 and the MSB code stream 901 are XORed to form a new LSB code stream 903. After the MSB code stream 901 and the new LSB code stream 903 are decoded 8B10B respectively, they are multiplexed into a binary code stream, which is the original binary code stream S.

In the embodiment of the present disclosure, the sub-coded signal is converted into Gray code signal according to Gray code conversion rule. Taking PAM4 coding as an example, the common PAM4 coding rules are that: binary 00 is coded as PAM code element 0, binary 01 is coded as PAM code element 1, binary 10 is coded as PAM code element 2 and binary 11 is coded as PAM code element 3. For PAM4 using Gray code, the coding rules are that: binary 00 is coded as PAM code element 0, binary 01 is coded as PAM code element 1, binary 11 is coded as PAM code element 2, and binary 10 is coded as PAM code element 3. For PAM4 modulation using Gray code, the binary codes represented by two adjacent PAM4 code elements are only different in one bit, and the error code elements caused by code element misjudgment are often adjacent code elements, and each code element error resulting error rate of two bits is very low, so that the bit error rate is lower than that of ordinary PAM4 modulation.

In a possible implementation, the modulated signal includes a dual-binary modulated signal. Step S203, performing modulation processing on the coded signal to obtain a modulated signal, includes:
performing duobinary modulation to the coded signal to obtain a duobinary modulated signal.

In the embodiment of the present disclosure, the coded signal is subjected to duobinary modulation processing on obtain a duobinary modulated signal. The duobinary modulated signal is a duobinary code. The duobinary code converts the original binary logical signal “1” or “0” into logical signals “+1”, “−1” and “0” according to certain rules, so that the spectrum bandwidth of the signal is reduced to half of the original spectrum bandwidth of the signal. The use of duobinary modulation can reduce the bandwidth occupied by the signal, improve frequency utilization, and increase the transmission distance of optical signals in optical fibers.

In the embodiment of the present disclosure, the coded signal is subjected to duobinary modulation processing. Compared with the PAM4 modulated signal, the duobinary transmission has better MPI tolerance. At the transmitting end, the signal transmitted by the source is subjected to DC balance coding, and after dual-binary modulation, high-pass filtering is used at the receiving end, which can better reduce MPI noise interference.

FIG. 10 is a flow chart of a signal processing method according to an exemplary embodiment. As shown in 10,
the modulated signal includes a dual-binary modulated signal. In Step S203, performing the modulation processing on the coded signal to obtain the modulated signal includes:
obtaining a coded signal delayed by a preset number of bits from the coded signal;
performing XOR processing on the coded signal and the coded signal delayed by the preset number of bits to obtain a pre-coded signal; and
performing precoding processing and duobinary modulation processing on the pre-coded signal to obtain the duobinary modulated signal.

In the embodiment of the present disclosure, before the duobinary modulation processing, referring to the pre-coding and duobinary coding 1002 in FIG. 10, the pre-coding signal is subjected to pre-coding processing and duobinary modulation processing on obtain a duobinary modulated signal. The pre-coding process includes delaying the pre-coded signal by preset bits to obtain a delayed pre-coded signal; and performing XOR processing on the delayed pre-coded signal and the pre-coded signal. Through the above pre-coding processing, the decision making at the receiving end is simpler, and the bit error rate in duobinary transmission can be reduced. However, the pre-coding process will destroy the DC balance characteristics of the coded signal. Therefore, referring to the XOR process 1001 in FIG. 10, the embodiment of the present disclosure obtains the coded signal delayed by preset bits from the coded signal, and performs the coding on the coded signal. XOR processing is performed with the coded signal delayed by the preset bits to obtain a pre-coded signal. Through the above XOR processing, embodiments of the present disclosure can make the final duobinary modulated signal possess DC balanced properties. In FIG. 10, ⊕ represents XOR logic, z⁻¹ means delaying one bit, \textcircled{Σ} represents the algebraic sum.

Referring to FIG. 11, at the receiving end, the high-pass filtered duobinary modulated signal undergoes duobinary decoding, and the resulting binary code stream is XORed with 1101 to obtain an 8B10B coded binary code stream. Finally, the 8B10B coded binary code stream is decoded to recover the original binary code stream. In one example, the duobinary decoding method may include: if a duobinary±1 code element is received, it is determined as bit 0; if a duobinary 0 code element is received, it is determined as bit 1. By using this method, the original binary code stream can be restored without requiring pre-decoding.

Through the embodiments of the present disclosure, a DC-balanced duobinary coding method is provided. This method reduces the bit error rate of duobinary coding. At the receiving end, the duobinary code stream undergoes high-pass filtering to obtain a processed signal, which improves the tolerance of the duobinary code stream to MPI noise.

In a possible implementation, the DC balanced coding includes at least one of the following: 8B10B coding, MB810 coding, 5S/6S coding, and 27S/32S coding.

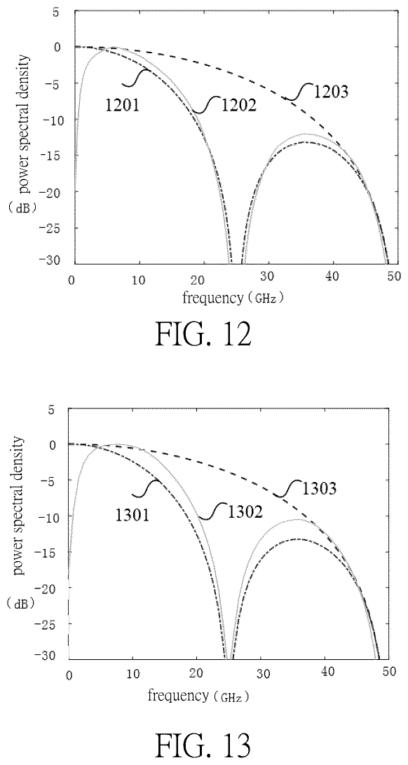

Referring to FIG. 12, curve 1203 represents the power spectral density of the 50 Gbaud/s NRZ signal, curve 1201 represents the power spectral density of the 25 Gbaud/s PAM4 signal, and curve 1202 represents the power spectral density of the 25 Gbaud/s 8B10B+PAM4 signal. The bit rates of the three signals are all 50 Gb/s, but the power spectral density of the 25 Gbaud/s PAM4 signal and the 25 Gbaud/s 8B10B+PAM4 signal is only half the bandwidth of the 50 Gbaud/s NRZ signal. The 25 Gbaud/s 8B10B+PAM4 signal has no zero frequency component, so it is a DC balanced signal.

Referring to FIG. 13, curve 1303 represents the power spectral density of the 50 Gbaud/s NRZ signal, curve 1301 represents the power spectral density of the 25 Gbaud/s duobinary signal, and curve 1302 represents the power spectral density of the 25 Gbaud/s duobinary coding+8B10B signal. The bit rates of these three signals are all 50 Gb/s. The bandwidths of the 25 Gbaud/s duobinary signal and the 25 Gbaud/s duobinary coding+8B10B signal are only half of that of the 50 Gbaud/s NRZ signal. Additionally, the 25 Gbaud/s duobinary coded+8B10B signal has no zero-frequency component and is therefore a DC-balanced signal.

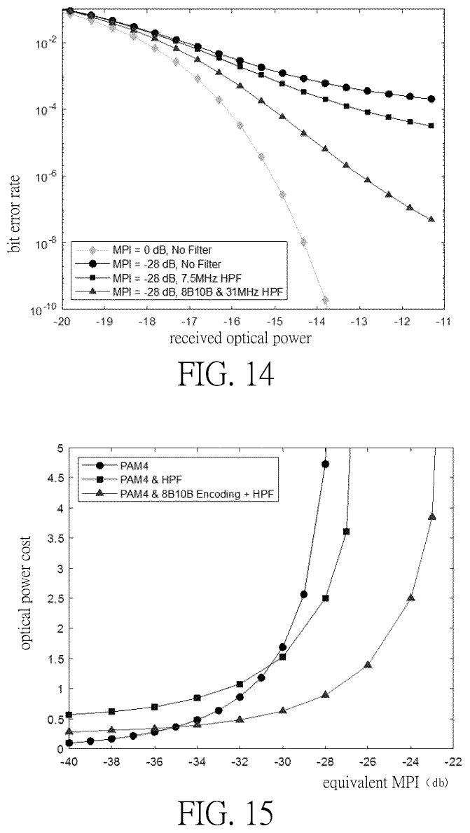

Refer to FIG. 14, which shows the variation curve of the bit error rate of 25 Gbuad PAM4 optical transmission with the received optical power. Among them, MPI=0 means that there is no MPI bit error rate in the optical fiber link, and MPI=−28 dB is the equivalent MPI bit error rate of −28 dB in the optical fiber link. It can be seen that MPI=−28 dB has a great impact on the bit error rate, which is several orders of magnitude worse than the bit error rate without MPI. MPI=−28, 7.5 MHz HPF is the bit error rate after the traditional PAM4 signal is transmitted through optical fiber and the receiving end adopts high-pass filtering. The high-pass filter can partially filter out the MPI noise, but it will also cause certain noise to the traditional MPI signal. Distortion (such as baseline drift, baseline wanderer), so the cutoff frequency of the high-pass filter needs to be optimized to achieve the minimum bit error rate. In the figure, MPI=−28, 7.5 MHz HPF is the bit error rate after optimization of the high-pass filter cutoff frequency (7.5 MHz). Compared with the bit error rate without filter (black dot), the performance is slightly improved. In the figure, MPI=−28, 8B10B & 31 MHz HPF is the bit error rate of the 8B10B coded PAM4 signal after being transmitted through optical fiber under the equivalent MPI=−28 dB. Since the receiving end uses a high-pass filter (the cutoff frequency is 31 MHz after optimization), MPI noise is filtered out to the greatest extent, with little impact on the PAM4 signal, so the bit error rate is improved by several orders of magnitude compared to the bit error rate without filtering.

Refer to FIG. 15, which shows that under different effective MPI, 25 Gbaud/s PAM4 optical transmission is compared with no optical power penalty for MPI optical transmission. Dot PAM4 is the optical power cost of traditional PAM4 transmission under different MPIs. If the optical power cost is limited to ≤1 dB, then the tolerance of 25 Gbaud/s PAM4 optical transmission to MPI is about −32 dB. The square point is the optical power cost of PAM4 & HPF of 25 Gbaud/s after PAM4 is transmitted through optical fiber and high-pass filtered at the receiving end; the receiving end adopts high-pass filtering with a cutoff frequency of 7.5 MHz. At this time, tolerance of the transmission system to MPI is approximately −31 dB. Compared with the case where there is no high-pass filter at the receiving end, the MPI tolerance is improved by 1 dB. The triangle in the figure is PAM4 & 8B10BCoding+HPF, which is the optical power cost when the transmitting end uses 8B10B PAM4 coding and the receiving end uses a high-pass filter with a cutoff frequency of 31 MHz. The tolerance of the system to MPI is about −27 dB. Compared with without 8B10B coding, without high-pass filtering at the receiving end (as shown by the dots), the MPI tolerance increases by 5 dB. It can be seen that through DC balanced coding (such as 8B10B or MB810) at the transmitting end and high-pass filtering at the receiving end, the tolerance of the optical communication system to MPI can be effectively improved.

It should be understood that, although various steps in the flowchart are illustrated in sequence with arrows, these steps are not necessarily required to be executed in the order indicated. Unless explicitly stated otherwise in this article, there is no strict limitation on the order of execution for these steps, and they may be performed in different sequences. Furthermore, at least some of the steps shown in the figure may consist of multiple sub-steps or stages. These sub-steps or stages are not required to be executed simultaneously and may be performed at different times. The order of execution of these sub-steps or stages does not necessarily follow a strict sequential flow; instead, they may be executed in parallel, alternately, or in combination with other steps or sub-steps from other stages.

It should be understood that the same or similar parts among various embodiments of the methods described in this specification can be cross-referenced. Each embodiment primarily focuses on the distinctions compared to other embodiments. For details regarding overlapping or related parts, reference can be made to the descriptions provided in other embodiments of the methods.

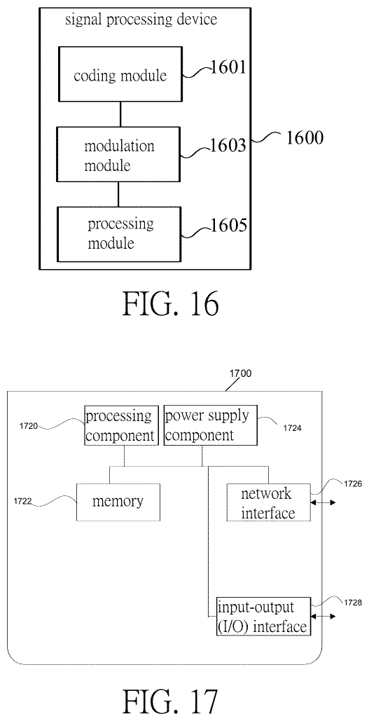

FIG. 16 is a schematic block diagram of a signal processing device according to an exemplary embodiment. Referring to FIG. 16, the device 1600 includes:
a coding module 1601, configured to perform DC balance coding on a signal emitted by a signal source to obtain a coded signal;
a modulation module 1603, configured to perform modulation processing the coded signal to obtain a modulated signal;
a processing module 1605, configured to transmit the modulated signal to a receiving end to instruct the receiving end to perform high-pass filtering on a received modulated signal to obtain a modulated signal with a frequency higher than a preset value, and perform demodulation processing and decoding processing on the modulated signal with the frequency higher than the preset value to obtain a processed signal.

In a possible implementation, the modulation processing includes pulse amplitude modulation processing, and the coding module includes:
a determination sub-module, configured to determine a number of signals transmitted by the signal source to be demultiplexed according to a modulation order of a pulse amplitude modulation;
a demultiplexing sub-module, configured to demultiplex the signal into a number of sub-signals;
a coding sub-module, configured to perform the DC balance coding on the number of sub-signals respectively to obtain a number of sub-coded signals;
wherein the modulation module includes:
a first modulation sub-module, configured to perform the pulse amplitude modulation according to the number of sub-coded signals to obtain the modulated signal.

In a possible implementation, the first modulation sub-module includes:
a conversion unit, configured to convert the number of sub-coded signals into Gray code signals according to Gray code conversion rule; and
a modulation unit, configured to the pulse amplitude modulation according to the Gray code signals to obtain the modulated signal.

In a possible implementation, the modulated signal includes a duobinary modulated signal, and the modulation module includes:
a second modulation sub-module, configured to perform duobinary modulation to the coded signal to obtain the duobinary modulated signal.

In a possible implementation, the modulated signal includes a duobinary modulated signal, and the modulation module includes:
an obtaining sub-module, configured obtain to a coded signal delayed by a preset number of bits from the coded signal;
a processing sub-module, configured to perform XOR processing on the coded signal and the coded signal delayed by the preset number of bits to obtain a pre-coded signal; and
a third modulation sub-module, configured to perform pre-coding processing and duobinary modulation processing on the pre-coded signal to obtain the duobinary modulated signal.

In a possible implementation, the DC balanced coding includes at least one of the following:
8B10B coding, MB810 coding, 5S/6S coding, and 27S/32S coding.

According to a third aspect of an embodiment of the present disclosure, a signal processing system is provided, including a transmitting end and a receiving end, wherein the transmitting end includes:
an encoder, configured to perform DC balanced coding on a signal emitted by a signal source to obtain a coded signal;
a modulator, configured to perform modulation processing on the coded signal to obtain a modulated signal; and
a modulated laser, configured to transmit the modulated signal to the receiving end;
wherein the receiving end includes:
a photoelectric receiving end, configured to receive a modulated signal;
a high-pass filter, configured to perform high-pass filtering on a received modulated signal to obtain a modulated signal with a frequency higher than the preset value; and
a decoder, configured to demodulate and decode the modulated signal with the frequency higher than the preset value to obtain a processed signal.

Regarding the devices in the above embodiments, the specific manner in which each module performs operations has been described in detail in the embodiments related to the method, and will not be described in detail here.

FIG. 17 is a block diagram of an electronic device 1700 for signal processing according to an exemplary embodiment. For example, the electronic device 1700 may be a server. Referring to FIG. 17, the electronic device 1700 includes a processing component 1720, which further includes one or more processors, and memory resources, represented by a memory 1722, for storing instructions, such as application programs, executable by the processing component 1720. Applications stored in memory 1722 may include one or more modules, each of which corresponds to a set of instructions. Furthermore, the processing component 1720 is configured to execute instructions to perform the above-described method.

The electronic device 1700 may also include a power supply component 1724 configured to perform power management of the electronic device 1700, a wired or wireless network interface 1726 configured to connect the electronic device 1700 to a network, and an input-output (I/O) interface 1728. The electronic device 1700 may operate based on an operating system stored in the memory 1722, such as Windows Server, Mac OS X, Unix, Linux, FreeBSD or the like.

In an exemplary embodiment, a computer-readable storage medium including instructions, such as the memory 1722 including instructions, which can be executed by a processor of the electronic device 1700 to complete the above method. The storage medium may be a computer-readable storage medium, for example, the computer-readable storage medium may be ROM, random access memory (RAM), CD-ROM, magnetic tape, floppy disk, optical data storage device, etc.

In an exemplary embodiment, a computer program product is also provided, the computer program product includes instructions, and the instructions can be executed by a processor of the electronic device 1700 to complete the above method.

It should be noted that the aforementioned devices, electronic equipment, computer-readable storage media, computer program products, and the like may include additional implementations based on the descriptions of the method embodiments. For specific implementation details, please refer to the descriptions provided in the relevant method embodiments, which will not be repeated here for brevity.

Other embodiments of the disclosure will be readily apparent to those skilled in the art upon consideration of the specification and the practice of the disclosure as described herein. The present disclosure is intended to encompass any variations, applications, or adaptations that adhere to the general principles of the disclosure and employ customary or well-known technical means within the field, even if not explicitly disclosed herein. The specification and examples provided are illustrative only, with the true scope and spirit of the disclosure defined by the appended claims.

It is understood that the present disclosure is not confined to the precise structures described above or illustrated in the accompanying drawings. Various modifications and alterations can be made without departing from the scope of the disclosure. The scope is defined solely by the appended claims.

1. A signal processing method, characterized in that it is applied to a transmitting end, and the method includes:
performing DC balance coding on a signal emitted by a signal source to obtain a coded signal;
performing modulation processing on the coded signal to obtain a modulated signal; and
transmitting the modulated signal to a receiving end to instruct the receiving end to perform high-pass filtering on a received modulated signal to obtain a modulated signal with a frequency higher than a preset value, and performing demodulation processing and decoding processing on the modulated signal with the frequency higher than the preset value to obtain a processed signal.

2. The method according to claim 1, wherein the modulation processing includes a pulse amplitude modulation processing, and performing the DC balance coding on the signal emitted by the signal source to obtain the coded signal includes:
determining a number of signals transmitted by the signal source to be demultiplexed according to a modulation order of a pulse amplitude modulation; and
demultiplexing the signal into a number of sub-signals;
performing the DC balance coding on the number of sub-signals respectively to obtain a number of sub-coded signals;
wherein performing the modulation processing on the coded signal to obtain the modulated signal includes:
performing the pulse amplitude modulation according to the number of sub-coded signals to obtain the modulated signal.

3. The method according to claim 2, characterized in that, performing the pulse amplitude modulation on the sub-coded signals according to the number of sub-coded signals to obtain the modulated signal, includes:
converting the number of sub-coded signals into Gray code signals according to Gray code conversion rule; and
performing the pulse amplitude modulation according to the Gray code signals to obtain the modulated signal.

4. The method according to claim 1, wherein the modulated signal includes a duobinary modulated signal, and performing the modulation processing on the coded signal to obtain the modulated signal includes:
performing duobinary modulation to the coded signal to obtain a duobinary modulated signal.

5. The method according to claim 1, wherein the modulated signal includes a duobinary modulated signal, and performing the modulation processing on the coded signal to obtain the modulated signal includes:
obtaining a coded signal delayed by a preset number of bits from the coded signal;
performing XOR processing on the coded signal and the coded signal delayed by the preset number of bits to obtain a pre-coded signal; and
performing pre-coding processing and duobinary modulation processing on the pre-coded signal to obtain the duobinary modulated signal.

6. The method according to claim 1, characterized in that the DC balanced coding includes at least one of the following:
8B10B coding, MB810 coding, 5S/6S coding, and 27S/32S coding.

7. A signal processing device, characterized in that it includes:
a coding module, configured to perform DC balance coding on a signal emitted by a signal source to obtain a coded signal;
a modulation module, configured to perform modulation processing the coded signal to obtain a modulated signal;
a processing module, configured to transmit the modulated signal to a receiving end to instruct the receiving end to perform high-pass filtering on a received modulated signal to obtain a modulated signal with a frequency higher than a preset value, and perform demodulation processing and decoding processing on the modulated signal with the frequency higher than the preset value to obtain a processed signal.

8. The device according to claim 7, wherein the modulation processing includes a pulse amplitude modulation processing, and the coding module includes:
a determination sub-module, configured to determine a number of signals transmitted by the signal source to be demultiplexed according to a modulation order of a pulse amplitude modulation;
a demultiplexing sub-module, configured to demultiplex the signal into a number of sub-signals;
a coding sub-module, configured to perform the DC balance coding on the number of sub-signals respectively to obtain a number of sub-coded signals;
wherein the modulation module includes:
a first modulation sub-module, configured to perform the pulse amplitude modulation according to the number of sub-coded signals to obtain the modulated signal.

9. The device according to claim 8, characterized in that the first modulation sub-module includes:
a conversion unit, configured to convert the number of sub-coded signals into Gray code signals according to Gray code conversion rule; and
a modulation unit, configured to the pulse amplitude modulation according to the Gray code signals to obtain the modulated signal.

10. The device of claim 7, wherein the modulated signal includes a duobinary modulated signal, and the modulation module includes:
a second modulation sub-module, configured to perform duobinary modulation to the coded signal to obtain the duobinary modulated signal.

11. The device according to claim 7, wherein the modulated signal includes the duobinary modulated signal, and the modulation module includes:
an obtaining sub-module, configured obtain to a coded signal delayed by a preset number of bits from the coded signal;
a processing sub-module, configured to perform XOR processing on the coded signal and the coded signal delayed by the preset number of bits to obtain a pre-coded signal; and
a third modulation sub-module, configured to perform pre-coding processing and duobinary modulation processing on the pre-coded signal to obtain the duobinary modulated signal.

12. The device according to claim 7, characterized in that the DC balanced coding includes at least one of the following:
8B10B coding, MB810 coding, 5S/6S coding, and 27S/32S coding.

13. A signal processing system, characterized by including a transmitting end and a receiving end, wherein the transmitting end includes:
an encoder, configured to perform DC balanced coding on a signal emitted by a signal source to obtain a coded signal;
a modulator, configured to perform modulation processing on the coded signal to obtain a modulated signal; and
a modulated laser, configured to transmit the modulated signal to the receiving end;
wherein the receiving end includes:
a photoelectric receiving end, configured to receive a modulated signal;
a high-pass filter, configured to perform high-pass filtering on a received modulated signal to obtain a modulated signal with a frequency higher than the preset value; and
a decoder, configured to demodulate and decode the modulated signal with the frequency higher than the preset value to obtain a processed signal.

14. An electronic device, characterized by including:
a processor;
a memory, configured to store instructions executable by the processor;
wherein, the processor is configured to execute the instructions to implement the signal processing method according to claim 1.

15. A computer-readable storage medium, characterized in that, when the instructions in the computer-readable storage medium are executed by a processor of an electronic device, the electronic device is enabled to perform the signal processing method as according to claim 1.

16. A computer program product, the computer program product including instructions, characterized in that when the instructions are executed by a processor of an electronic device, the electronic device can perform the signal processing method according to claim 1.
